(19) United States
(12) Patent Application Publication
(10) Pub. No.: US 2024/0100813 A1
(43) Pub. Date: Mar. 28, 2024

(54) LAMINATION FILM STRUCTURE

(71) Applicant: Dow Global Technologies LLC, Midland, MI (US)

(72) Inventors: Shenglong Chen, Shanghai (CN); Weiming Ma, Shanghai (CN); Jingyi Xu, Shanghai (CN)

(73) Assignee: Dow Global Technologies LLC, Midland, MI (US)

(21) Appl. No.: 18/263,731

(22) PCT Filed: Apr. 30, 2021
(86) PCT No.: PCT/CN2021/091532

§ 371 Date: Aug. 1, 2023

(51) Int. Cl. B32B 27/08; B32B 27/32

(52) U.S. Cl. CPC B32B 27/08; B32B 27/32; B32B 2305/70; B32B 2307/518; B32B 2307/72

(57) ABSTRACT

A lamination film structure including a combination of: (a) at least one first layer of an oriented polyethylene film and (b) at least one second layer of a blown or cast polyethylene film, wherein the first oriented polyethylene film layer is laminated with the second blown or cast polyethylene film layer; and wherein the blown or cast polyethylene film of component (b) is a blown polyethylene film or a cast polyethylene film comprising a formulated resin including a combination or mixture of: (bi) a predetermined amount of a post-consumer recycled resin sourced from a recycled high density polyethylene resin; and (bii) a predetermined amount of a polyethylene resin; a process for making the above lamination film structure; and a film or article made from a recyclate of the above lamination film structure.

### FIELD

The present invention relates to lamination film structures and processes of making such lamination film structures; and more specifically, the present invention relates to lamination film structures including films which include post-consumer resins in combination with polyethylene resins and processes for making such lamination film structures.

### BACKGROUND

Using recycled materials is thought to be better for the environment and decreases the waste of natural resources that are used for disposable products. Typically, the largest source for recycled material is the plastics packaging industry (e.g., plastics used in manufacturing containers such as milk jugs, plastic bags and refillable plastic bottles). For example, high-density polyethylene (HDPE) is one of the most commonly used plastics in milk jugs, plastic bags and refillable plastic bottles; and HDPE can be easily recycled. HDPE has a high recyclability potential because nearly all HDPE containers are made from same-grade resins, fractional melt index homopolymers. This results in a homogeneous feed stream with consistent material characteristics evident in predictable performance properties and flow (processing) characteristics.

It would be favorable for the plastics industry to develop methods for recycling plastic material, which would otherwise go to waste by being burned or placed in a landfill. However, the use of recycled materials has drawbacks. It is generally recognized in the art that recycled materials often result in products that have physical properties which are generally less acceptable than products made from virgin materials. As a result, the number and concentration of recycled materials used to fabricate products is often limited due to the loss in physical properties of the products prepared from recycled materials.

One enduse, where there is a growing demand for recycled materials, is in the fabrication of lamination films for packaging applications. Packaging is an area where recycled plastic or post-consumer recycled (PCR) materials or resins can be advantageously used to provide an acceptable and environmentally advantageous lamination film or packaging product. And, the use of PCR materials to forge a circular economy can be significantly beneficial.

Oriented lamination films such as biaxially-oriented polyethylene terephthalate//polyethylene (BOPET//PE) films and biaxially oriented polyamide//polyethylene (BOPA//PE) films are typical lamination film structures known and used in the art for packaging applications. It is also known that such BOPET//PE and BOPA//PE lamination film structures are difficult to recycle because the BOPET and PE or the BOPA and PE polymers that make up the layers of the film structures are incompatible at the point of forming a recyclate from the film structures (e.g., shredding the film structures and forming a pellet from the film structures). In addition, even if the BOPET//PE and BOPA//PE lamination film structures can be made into a secondary recycled film, the recycled film does not possess the required properties to adequately use the recycled film in applications such as packaging applications. Heretofore, to provide a compatible and recyclable lamination film structure with the proper physical properties, it has been required that the lamination film structure consist of all-polyethylene (all-PE) film layers in the lamination film structure, i.e., only virgin resins could be used to make the lamination film without using any recycled material in the PE film layer. A typical film structure used in previous packaging applications includes, for example, a biaxially oriented polyethylene//polyethylene (BOPE//PE) layer. While an all-PE film structure is best to use in packaging applications, there is an increased demand for film manufacturers to provide a film structure that can, inter alis: (1) include PCR material; (2) retain the proper properties required for use in packaging; and, (3) advantageously, be recycled.

Some references, such as PCT/CN2018/124980; EP3317103B1; U.S. Ser. No. 10/792,899; WO/2018/195681; WO/2020/046936; and PCT/CN2020/111758; disclose a biaxially oriented polyethylene (BOPE) or BOPE lamination to improve the adhesive bond strength or sealing performance of a laminated film. For example, an all-PE film structure is described in PCT/CN2018/124980. However, the use of a PCR material is not taught in the above reference.

Other references, including EP3406666A1; CN109824925A; US20200010652A1; EP2631051A1; and CA2078309A1; disclose PCR materials used in various recycling processes, PE compositions, and multilayer film structures. For example, a polyethylene (PE) composition is described in EP3406666A1, wherein the composition includes a melt blend of component “A” being a PE post-consumer resin (a PCR material); and component “B” being a chromium-catalyzed PE. However, BOPE is not taught in the above prior art reference.

Therefore, it would be desirous to provide: (1) a formulated PCR material or resin useful for fabricating a film structure (e.g., a PCR-containing PE film) that can be laminated with a BOPE film to form a lamination film structure; (2) a lamination film comprising a PE with a high toughness resin (e.g., HDPE) incorporated with a PCR material such that the resulting PCR-containing PE lamination film has a comparable performance to an all-PE lamination film made from virgin resins; and (3) a lamination film which is suitable for non-food packaging applications.

### SUMMARY

A solution to the above recyclability problems of the prior art includes the use of PCR material (sourced, for example, from natural HDPE blow molding bottles) in combination with PE resin to form a first film and then laminating the PE-PCR first film with a BOPE second film to produce a multilayer lamination film structure useful, for example, for non-food grade contacted collation shrink films and secondary packaging.

In one embodiment, the present invention is directed to a PE lamination film structure, wherein the PE lamination film structure comprises (a) at least one first layer of an oriented polyethylene (OPE) film laminated with (b) at least one second layer of a blown or cast PE film.

In one preferred embodiment, the OPE film, component (a), includes, for example, a tenter frame biaxially oriented polyethylene (TF-BOPE) film.

In another embodiment, the blown or cast PE film, component (b), includes, for example, a blown or cast PE film comprising a formulated resin of: (bi) a PCR material sourced from a recycled HDPE resin; and (bii) a PE resin. The PE resin, component (bii) includes, for example, (biiα) a linear low-density polyethylene (LLDPE) resin; (biiβ) a low density polyethylene (LDPE) resin; or (biiγ) a combination of (biiα) a LLDPE resin and (biiβ) a LDPE resin.

Another embodiment of the present invention is directed to a process for making the above PE lamination film structure.

### DETAILED DESCRIPTION

Temperatures herein are in degrees Celsius (° C.).

“Room temperature (RT)” and “ambient temperature” herein means a temperature between 20° C. and 26° C., unless specified otherwise.

A “post-consumer recycled (PCR) material” or “PCR resin” is defined by ISO 14021:2016 as a material generated by households or by commercial, industrial and institutional facilities in such facilities' role as end-users of the product which can no longer be used for the product's intended purpose. PCR materials includes returns of material from the distribution chain. The PCR material is often sourced from a blend of, for example but not limited thereto, two or more compounds such as the combination of a LLDPE and a LDPE; a polyamide (PA) and ethylene vinyl alcohol (EVOH); and a HDPE and a polypropylene (PP).

The term “recyclate” means a raw material that is sent to, and processed in, a waste recycling plant or a materials recovery facility; and that can be processed or recovered such that the resulting processed or recovered material can be used to form new products. The recyclate material is collected using various methods and delivered to a facility where the recyclate material is processed so that the recyclate material can be used in the production of new materials or new products. For example, plastic bottles (recyclate) can be collected and delivered to a facility where the plastic bottles can be processed so that the plastic bottles can be made into plastic pellets, a new product. Thus, the plastic bottles can be re-used (recycled) after the initial use of the plastic bottles.

As used herein, the term “polyethylene” or “ethylene-based polymer” shall mean polymers comprising greater than 50% by mole of units which have been derived from ethylene monomer. This includes polyethylene homopolymers or copolymers (meaning units derived from two or more comonomers). Common forms of polyethylene known in the art include LDPE; LLDPE; medium density polyethylene (HDPE); and HDPE.

The term “LDPE” may also be referred to as “high pressure ethylene polymer” or “highly branched polyethylene” and is defined to mean that the polymer is partly or entirely homopolymerized or copolymerized in autoclaves or tubular reactors at pressures above 14,500 psi (100 MPa) with the use of free-radical initiators, such as peroxides (see, for example, U.S. Pat. No. 4,599,392). LDPE resins typically have a density in the range of 0.915 g/cm to 0.935 g/cm.

The term “LLDPE” includes: (1) resins made using Ziegler-Natta catalyst systems; (2) resins made using single-site catalysts, including, but not limited to, bis-metallocene catalysts (sometimes referred to as “m-LLDPE”); (3) resins made using constrained geometry catalysts; and resins made using post-metallocene, molecular catalysts. LLDPEs include linear, substantially linear or heterogeneous polyethylene copolymers or homopolymers. LLDPEs contain less long chain branching than LDPEs. LLDPEs include, for example, (1) substantially linear ethylene polymers, such as the substantially linear ethylene polymers further defined in U.S. Pat. Nos. 5,272,236; 5,278,272; 5,582,923; and 5,733,155; (2) homogeneously branched linear ethylene polymer compositions such as the homogeneously branched linear ethylene polymer compositions described in U.S. Pat. No. 3,645,992; (3) heterogeneously branched ethylene polymers such as the heterogeneously branched ethylene polymers prepared according to the process disclosed in U.S. Pat. No. 4,076,698; and/or (4) blends of two or more of the above LLDPEs (such as the blends disclosed in U.S. Pat. No. 3,914,342 or 5,854,045). The LLDPE resins can be made via gas-phase, solution-phase or slurry polymerization or any combination thereof, using any type of reactor or reactor configuration known in the art.

The term “MDPE” refers to polyethylenes having densities from 0.926 g/cc to 0.945 g/cc. “MDPE” is typically made using chromium catalysts, Ziegler-Natta catalysts, or single-site catalysts including, but not limited to, bis-metallocene catalysts and constrained geometry catalysts.

The term “HDPE” refers to polyethylenes having densities greater than 0.945 g/cc, which are generally prepared with Ziegler-Natta catalysts, chrome catalysts, or single-site catalysts including, but not limited to, bis-metallocene catalysts and constrained geometry catalysts.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like.).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; “MT”=metric ton(s); g=gram(s); mg=milligram(s); kg=kilogram(s); kg/hr=kilogram(s) per hour; g/L=gram(s) per liter; “g/cm³” or “g/cc”=gram(s) per cubic centimeter; g/m²=gram(s) per square meter; “kg/m³=kilogram(s) per cubic meter; ppm=parts per million by weight; pbw=parts by weight; rpm=revolutions per minute; m=meter(s); m/min=meter(s) per minute; mm=millimeter(s); cm=centimeter(s); μm=micron(s), min=minute(s); s=second(s); ms=millisecond(s); hr=hour(s);

Pa=pascals; Pa=megapascals; Pa-s=Pascal second(s); mPa-s=millipascal second(s); g/mol=gram(s) per mole(s); g/eq=gram(s) per equivalent(s); Mₙ=number average molecular weight; M_{w}=weight average molecular weight; pts=part(s) by weight; 1/s or sec⁻¹=reciprocal second(s) [s⁻¹]; ° C.=degree(s) Celsius; psig=pounds per square inch; kPa=kilopascal(s); N=newton(s); mN=millinewton(s); %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

In one broad embodiment, the present invention includes a PE lamination film, wherein the structure of the PE lamination film comprises (a) at least one first layer of an OPE film in combination with (b) at least one second layer of a blown or cast PE film which includes a predetermined amount of PCR material incorporated into the at least one second layer blown or cast PE film of the PE lamination film. The OPE film is laminated with the blown or cast PE film containing the PCR material. Generally, the first layer of OPE film can be a monolayer or a multilayer; and the second layer of PCR resin can also be a monolayer or a multilayer.

In general, the OPE film of component (a) useful in the present invention includes, for example, various embodiments of oriented polyethylene films such as a BOPE or a monoaxially oriented polyethylene, wherein the polyethylene is oriented in either the machine direction (MD) or the cross or transverse direction (TD).

In some embodiments, the OPE film of component (a) includes, for example, a BOPE film; and in such embodiments in which the oriented PE film is BOPE, the BOPE may be biaxially oriented using a tenter frame sequential biaxial orientation process. When the tenter frame sequential biaxial orientation process is used, the BOPE may be referred to as a TF-BOPE. Such orientation techniques are generally known to those of skill in the art. In other embodiments, the OPE film can be biaxially oriented using other techniques known to those of skill in the art such as double bubble or triple bubble orientation processes. In general, with a tenter frame sequential biaxial orientation process, the tenter frame is incorporated as part of a multilayer co-extrusion line.

For example, after extruding from a flat die, the film is cooled down on a chill roll, and is immersed into a water bath filled with room temperature water. The resulting cast film is then passed onto a series of rollers with different revolving speeds to achieve stretching in the MD. There are several pairs of rollers in the MD stretching segment of the fabrication line, and the rollers are all oil heated. The paired rollers work sequentially as pre-heated rollers, stretching rollers, and rollers for relaxing and annealing. The temperature of each pair of rollers is separately controlled. After stretching in the MD, the film web is passed into a tenter frame hot air oven with heating zones to carry out stretching in the TD. The first several zones are for pre-heating, followed by zones for stretching, and then the last zones for annealing.

In some embodiments herein, the PE may have a density of, for example, from 0.900 g/cc to 0.950 g/cc in one general embodiment. All individual values and subranges of at least 0.900 g/cc to 0.950 g/cc are included and disclosed herein. For example, in some embodiments, the PE has a density of from 0.900 g/cc to 0.945 g/cc, 0.900 g/cc to 0.940 g/cc, 0.900 g/cc to 0.935 g/cc, 0.910 g/cc to 0.945 g/cc, 0.910 g/cc to 0.940 g/cc, 0.910 g/cc to 0.935 g/cc, 0.910 g/cc to 0.930 g/cc, 0.915 g/cc to 0.940 g/cc, 0.915 g/cc to 0.923 g/cc, or 0.920 g/cc to 0.935 g/cc. Density may be measured in accordance with ASTM D792.

In some embodiments herein, the PE may have a melt index, I₂, measured in accordance with ASTM D1238 at 190° C. and 2.16 kg of, for example, from 0.1 g/10 min to 10 g/10 min in one general embodiment. All individual values and subranges of at least 0.1 g/10 min to 10 g/10 min are included and disclosed herein. For example, in some embodiments, the polyethylene may have a melt index, 12, of from 0.1 g/10 min to 9.5 g/10 min, 0.1 g/10 min to 9.0 g/10 min, 0.1 g/10 min to 5 g/10 min, 0.5 g/10 min to 6 g/10 min, 1 g/10 min to 5 g/10 min, 1.5 g/10 min to 4.5 g/10 min, or 2 g/10 min to 4 g/10 min. In other embodiments, the polyethylene may have a melt index, I₂, of from 0.7 g/10 min to 9.5 g/10 min, 0.7 g/10 min to 8 g/10 min, or 0.7 g/10 min to 5 g/10 min. Melt index, I₂, may be measured in accordance with ASTM D1238 (at 190° C. and 2.16 kg).

In some embodiments herein, the PE may have a melt flow ratio, I₁₀/I₂, of less than 14. All individual values and subranges of less than 14 are included and disclosed herein. For example, in some embodiments, the PE may have a melt flow ratio, I₁₀/I₂, of less than 13.5, less than 13, less than 12.5, 10, or even less than 7.5. In other embodiments, the polyethylene may have a melt flow ratio, I₁₀/I₂, of from 1.0 to 14; 2 to 14; 4 to 14; 5 to 14; 5.5 to 14; 6 to 14; 5 to 13.5; 5 to 13; 5 to 12.5; 5 to 12; 5 to 11.5; 5 to 11; 5.5 to 13.5; 5.5 to 13; 5.5 to 12.5; 5.5 to 12; 5.5 to 11.5; 5.5 to 11; 6 to 13.5; 6 to 13; 6 to 12.5; 6 to 12; 6 to 11.5; or 6 to 11. Melt index, I₁₀, may be measured in accordance with ASTM D1238 (at 190° C. and 10.0 kg).

Commercially available oriented polyethylene films suitable for use in the present invention include, for example, TF-BOPE films available from Decro (Gunangdong, China). Commercial examples of suitable ethylene-based copolymers useful in the present invention include those sold under the trade names ATTANE™, DOWLEX™, ELITE™, ELITE™ AT and INNATE™ all available from The Dow Chemical Company; LUMICENE® available from Total SA; and EXCEED™ and EXACT™ available from ExxonMobil Chemical Company. The use of other commercially available mono- and bi-axially oriented films, as well as the use of other polyethylenes, are contemplated.

In other preferred embodiments, the OPE film of component (a) includes, for example, a TF-BOPE film; and one or more other OPE films such as the OPE films disclosed in U.S. Pat. No. 10,457,787.

The blown or cast PE film component (b) includes, for example, at least one layer of blown or cast PE film comprising a formulated resin. The formulated resin that makes up the blown or cast PE film, component (b), includes, for example, a formulated resin of: (bi) a predetermined amount of a post-consumer recycled resin (PCR) sourced from a recycled HDPE resin; and (bii) a predetermined amount of a PE resin. In a preferred embodiment, the PE resin, component (bii) includes, for example, (biiα) a LLDPE resin; (biiβ) a LDPE resin; or (biiγ) a combination of (biiα) a LLDPE resin and (biiβ) a LDPE resin.

As aforementioned, the PCR resin used in the formulated resin is sourced from recycled HDPE resin in one preferred embodiment. In general, the PCR resin may be sourced from packaging waste, such as material generated by households or by commercial, industrial and institutional facilities in their role as end-users of the product. In one or more embodiments, the PCR resin is sourced from HDPE plastic containers. In one or more embodiments, the PCR resin is sourced from HDPE blow-molded bottles (e.g., milk bottles, sauce bottles, and the like). In one embodiment, the HDPE blow molded bottles have a melt index, I₂, of 0.30 g/10 min±0.20 g/10 min and a density 0.95 g/cm³±0.02 g/cm³.

In one general preferred embodiment, the PCR resin has a density of from 0.94 g/cc to 0.97 g/cc; and the PCR resin has a melt index (MI), I₂, (@190° C., 2.16 kg) of less than 20 g/10 min. All individual values and subranges of the broad ranges described above are included and disclosed herein. For example, in some embodiments, the PCR resin has a density of from 0.94 g/cc to 0.97 g/cc in one general embodiment, from 0.945 g/cc to 0.965 g/cc in another embodiment, and from 0.95 g/cc to 0.96 g/cc in still another embodiment; and a melt index, I₂, of less than 20 g/10 min in one general embodiment, from 0.1 g/10 min to 10 g/10 min in another embodiment, and from 0.2 g/10 min to 5 g/10 min in still another embodiment.

In a preferred embodiment, the concentration of the PCR in the formulated resin that comprises the blown or cast PE film is, for example, from 40 wt % to 100 wt % in one embodiment; from 50 wt to 90 wt % in another embodiment; and from 60 wt % to 80 wt % in still another embodiment.

The formulated resin that makes up the blown or cast PE film also includes a predetermined amount of a PE resin. The PE resin, component (bii) can be selected from various PE resins known in the art including, for example, (biiα) a LLDPE resin; (biiβ) a LDPE resin; or (biiγ) a combination of (biiα) a LLDPE resin and (biiβ) a LDPE resin.

In one preferred embodiment, the PE resin, component (bii) used in the formulated resin to form the blown or cast PE film is a LLDPE resin because the LLDPE resin boosts the toughness and sealing performance of the blown or cast PE film. In one general embodiment, the LLDPE resin has a density of from 0.89 g/cc to 0.95 g/cc; and the LLDPE resin has a MI (@190° C., 2.16 kg) of less than 20 g/10 min. All individual values and subranges of the broad ranges described above are included and disclosed herein. For example, in some embodiments, the LLDPE resin has a density of from 0.89 g/cc to 0.95 g/cc in one general embodiment, from 0.895 g/cc to 0.945 g/cc in another embodiment, and from 0.90 g/cc to 0.94 g/cc in still another embodiment; and a melt index, I₂, of less than 20 g/10 min in one general embodiment, from 0.1 g/10 min to 10 g/10 min in another embodiment, and from 0.5 g/10 min to 5 g/10 min in still another embodiment.

Examples of suitable LLDPE resins that can be used in the present invention may include commercially available compounds such as TUFLIN™, DOWLEX™, DOWLEX™ NG, ELITE™, AFFINITY™, ELITE™ AT, and INNATE™ resins (all available from The Dow Chemical Company) and mixtures thereof; ENABLE™ and EXCEED™ resins (both available from ExxonMobil Chemical Company) and mixtures thereof; LUMICENE™ and SUPERTOUGH™ resins (both available from Total SA) and mixtures thereof; and two or more of the above resins in a blend. In some embodiments, specific examples of suitable LLDPE resins that can be used in the present invention may include, for example, DOWLEX™ 2045G resin, DOWLEX™ 2049G resin, DOWLEX™ 2098P resin, DOWLEX™ 2038.68G resin, DOWLEX™ 2645G resin and DOWLEX™ NG 5045P resin, ELITE™ 5400G, ELITE™ 5100G, AFFINITY™ PL 1880G, ELITE™ AT 6202, INNATE™ ST50, INNATE™ TH60 (all available from The Dow Chemical Company) and mixtures thereof.

Generally, the LLDPE used in the formulated resin to form the blown or cast PE film is prepared using Ziegler-Natta catalyst or metallocene catalyst, and the co-monomer is octene or hexane, or mixture thereof using processes known in the art.

The LLDPE concentration in the formulated resin to form the blown or cast PE film can be, for example, a concentration of from 0 wt % to 60 wt % in one embodiment; from 10 wt % to 50 wt % in another embodiment; and from 20 wt % to 40% wt % in still another embodiment.

The formulated resin used to form the blown or cast PE film, component (b), may include one or more optional additives. The optional additives in combination with the composition of the present invention may be formulated to enable performance of specific functions while maintaining the excellent benefits/properties of the formulation resin. For example, the following additives may be blended with the formulation resin: antioxidants, pigments, colorants, UV stabilizers, UV absorbers, processing aids, fillers, slip agents, anti-blocking agents, and the like; and mixtures thereof.

The optional additive, when used in the formulated resin, can be present in an amount generally in the range of from 0 wt % to 10 wt % in one embodiment; from about 0.001 wt % to 5 wt % in another embodiment; and from 0.001 wt % to 3 wt % in still another embodiment. In other embodiments, the optional additive may be added to the formulated resin in an amount of less than 5 wt % in one general embodiment, less than 3 wt % in another embodiment, and less than 1 wt % in still another embodiment.

In a general embodiment, the process for making the PE lamination film structure of the present invention includes the step of laminating (a) at least one first layer of an OPE film in combination with (b) at least one second layer of a blown or cast PE film having a particular amount of PCR material.

Any conventional film forming process may be used to form the blown or cast film. An example of a conventional film forming process includes a blown film line (for example, a blow line manufactured by Jinming Machinery) using typical fabrication parameters easily determined by those skilled in the art of producing blown films.

Any conventional film laminating process may be used to form the lamination film. An example of a conventional film laminating process includes a laminating line (for example, a laminating line manufactured by Nordmeccanica) using typical processing parameters easily determined by those skilled in the art of lamination films.

In some embodiments of the lamination process, one or more adhesives may be used to adhere (bond) together the OPE film and the blown or cast PE film. Suitable adhesives useful in the present invention can include, for example, solvent-based adhesives, solventless adhesives, water-based adhesives, and combinations thereof. Suitable adhesives may include, for example, polyurethane adhesives, epoxy adhesives, acrylic adhesives, and the like. In some embodiments, the adhesives may be one-part or two-part formulations. In some embodiments which include adhesives, one or more different adhesives may be used to adhere the layers to one another. The weight or thickness of the adhesive layer can depend on a number of factors including, for example, the desired thickness of the multilayer structure, the type of adhesive used, and other various factors known to those skilled in the art of adhesives. In some embodiments, the adhesive layer useful in the present invention is applied at a weight of up to 5.0 g/m² in one general embodiment, from 1.0 g/m² to 4.0 g/m² in another embodiment, and from 2.0 g/m² to 3.0 g/m² in still another embodiment.

In one general embodiment, the PE lamination film structure of the present invention can be used for preparing a first packaging, film and/or article for various applications including, for example, non-food packaging applications. After the first packaging, film or article is used by the consumer, the first packaging, film or article can advantageously be recycled using conventional recycling processes known to those skilled in the art of recycling materials. The process of recycling the PE lamination film structure of the present invention and/or packaging/film structures made from the PE lamination film structure provides a way to reduce the amount of plastic waste for the benefit of the environment.

In another general embodiment, the present invention includes fabricating a second packaging, film or article made from recycled material of the above first packaging, film or article. For example, a recycling material such as pellets can be produced from the first packaging, film or article. Then, a different second packaging, film or article can be made from the first recycled material (e.g., the aforementioned pellets). Some of the final products made from the first and/or the second packaging, film or article can include, for example, a collation shrink film; a package or plastic bag for packaging non-food items, a bottle for various uses, and the like.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise, stated all parts and percentages are by weight on a total weight basis.

The ingredients and raw materials used in the Examples are described in Table I.

TABLE I
Raw Materials

| | | | | Melt |
|---|---|---|---|---|
| | | | Density | Index |
| Product Name | Brief Description of Product | Supplier | (g/cc) | (MI) |
| LDPE 450E | A low density polyethylene | The Dow Chemical | 0.923 | 2 |
| | | Company (Dow) | | |
| AFFINITY ™ PL 1881G | A linear low density | Dow | 0.904 | 1 |
| | polyethylene | | | |
| ELITE ™ AT 6202 | A linear low density | Dow | 0.908 | 0.85 |
| | polyethylene | | | |
| DOWLEX ™ 2038.68G | A linear low density | Dow | 0.935 | 1 |
| | polyethylene | | | |
| INNATE ™ TH60 | A linear low density | Dow | 0.912 | 0.85 |
| | polyethylene | | | |
| INNATE ™ ST50 | A linear low density | Dow | 0.918 | 0.85 |
| | polyethylene | | | |
| AFFINITY ™ PL 1880G | A linear low density | Dow | 0.902 | 1 |
| | polyethylene | | | |
| ELITE ™ 5100G | A linear low density | Dow | 0.92 | 0.85 |
| | polyethylene | | | |
| XUS 59910.11 | A linear low density | Dow | 0.928 | 0.85 |
| | polyethylene | | | |
| Post-Consumer Recycle | A high density polyethylene | Luhai | 0.95 | 0.25 |
| (PCR) resin | and PCR material | | | |

### General Procedure for Preparing the Blown Film

The blown films used in the Examples include 80-μn three-layer films blown on a blow line manufactured by Jinming Machinery. The fabrication parameters of the blown films are as follows:
7-layer (A/B/C/D/E/F/G) pancake; die diameter: 120 mm; die gap: 1.5 mm; output: −25 kg/hr;
Die temperature profile: A,B: 215° C.; C,D,E: 220° C.; F,G: 215° C.;
Blow-up ratio (BUR): 2.4; layflat: 45 cm; 1st haul off speed: 6 m/min;
Extruder diameter: 30 mm; length/diameter (L/D) ratio: 30;
Extruder temperature profile: A: 170° C./205° C./210° C./210° C./210° C.; B/C/D/E/F: 190° C./
210° C./220° C./220° C./220° C.; G: 170° C./205° C./210° C./210° C./210° C.;
Corona treatment is on-line; and
Split winding is on-line.

A multilayer blown film is fabricated with a layered structure comprising A/B/C. The detailed formulation for each of the layers, A/B/C, used in the Examples are shown in Table II.

TABLE II
Blown PE Layer Formulations

| | A | B | C |
|---|---|---|---|
| Example No. | (Sealant Layer) | (Middle Layer) | (Skin Layer) |
| (PE, 80 μm) | 25% | 50% | 25% |
| Comp. Ex. A | 25% AFFINITY ™ PL 1881G + | 90% DOWLEX ™ | 100% ELITE ™ |
| | 50% ELITE ™ AT 6202 + 25% | 2038.68G + 10% LDPE | 5100G |
| | LDPE 450E + Slip + Anti-block | 450E | |
| Inv. Ex. 1 | 25% AFFINITY ™ PL 1881G + | 60% PCR + | 100% INNATE ™ |
| | 50% ELITE ™ AT 6202 + 25% | 40% INNATE ™ TH60 | ST50 |
| | LDPE 450E + Slip + Anti-block | | |
| Inv. Ex. 2 | 25% AFFINITY ™ PL 1881G + | 80% PCR + | 100% XUS 59910.11 |
| | 50% ELITE ™ AT 6202 + 25% | 20% AFFINITY ™ PL | |
| | LDPE 450E + Slip + Anti-block | 1880G | |
| Inv. Ex. 3 | 25% AFFINITY ™ PL 1881G + | 80% PCR + | 100% INNATE ™ |
| | 50% ELITE ™ AT 6202 + 25% | 20% AFFINITY ™ PL | TH60 |
| | LDPE 450E + Slip + Anti-block | 1880G | |

### General Procedure for Preparing Lamination Film

A 20-μm thick TF-BOPE film (DL20; a product purchased from Decro (Guangdong, China)) The DL20 film is fabricated with INNATE™ TF80 (0.926 g/cc density, 1.7 MI) on a biaxial orientation machine supplied by Bruckner GmbH. The film is stretched 4-5 times in the machine direction (MID) and stretched 8-9 times in the transverse direction (TD). A corona treatment is applied to one side of the film. For each of the Examples, the TF-BOPE is laminated with a blown PE film.

The lamination process is conducted on a Nordmeccanica Labo Combi pilot line. The processing parameters are as follows:
Adhesive used: MORFREE™ 709A/709B (wt %: 100/80), available from The Dow Chemical Company;
Coating weight of the adhesive: 1.8 g/m²;
Lamination speed: 50 m/min;
Oven temperature: 55° C., 65° C., 75° C.; and
Temperature of nip roll: 60° C.

### Testing Methods

### Density

Density is measured according to ASTM D792, Method B; and density is reported in grams/cubic centimeter (g/cc or g/cm³).

### Melt Index

Melt index (MI), or I₂, is measured in accordance with ASTM D 1238 at the conditions of 190° C./2.16 kg using Procedure B; and the I₂ value is reported in grams eluted per 10 minutes (g/10 min). The melt index or I₁₀, is measured in accordance with ASTM D 1238 at the conditions of 190° C./10 kg using Procedure B; and the I₁₀ value is reported in grams eluted per 10 minutes (g/10 min).

### Tensile Properties

ASTM D882 is used to measure the tensile strength, tensile elongation and secant modulus of the film.

### Tear Properties

ASTM D1922 is used to measure the tear properties of the film in the machine direction (MD) and the transverse direction (TD).

### Dart Properties

ASTM D1709, Procedure A, is used to measure the dart properties of the film.

### Puncture

Puncture of the film is measured using the same procedure described in ASTM D5748 except that a 12.7 mm diameter stainless steel probe is used.

### Results

Tables III and Table IV describe the mechanical properties of the blown PE films and the mechanical properties of the lamination films, respectively, as measured and recorded in accordance with the above testing procedures.

TABLE III
Mechanical Properties of Blown PE Films

| | | | 2% | | | 2% | | | | |
|---|---|---|---|---|---|---|---|---|---|---|
| | Tensile | Tensile | Secant | Tensile | Tensile | Secant | | | | |
| | Stress | Strain | Modulus | Stress | Strain | Modulus | Dart | Puncture | Tear | Tear |
| Example No. | MD | MD | MD | TD | TD | TD | A, | Force | MD | TD, |
| (PE, 80 μm) | (MPa) | (%) | (MPa) | (MPa) | (%) | (MPa) | (g) | (N) | (mN) | (mN) |
| Comp. Ex. A | 32.63 | 910.03 | 312.79 | 30.79 | 943.41 | 318.86 | 411 | 50.29 | 313 | 730 |
| Inv. Ex. 1 | 29.78 | 824.32 | 378.96 | 29.73 | 896.28 | 408.81 | 711 | 59.3 | 783.9 | 1756 |
| Inv. Ex. 2 | 29.53 | 798.28 | 458.87 | 27.61 | 853.93 | 499.59 | 441 | 60.95 | 323.7 | 1575 |
| Inv. Ex. 3 | 32.41 | 848.62 | 404.52 | 30.77 | 912.86 | 443.82 | 468 | 59.43 | 414.5 | 1701 |

TABLE IV
Mechanical Properties of Lamination Films

| | | | 2% | | | 2% | | | | |
|---|---|---|---|---|---|---|---|---|---|---|
| | Tensile | Tensile | Secant | Tensile | Tensile | Secant | | | | |
| Example No. | Stress | Strain | Modulus | Stress | Strain | Modulus | Dart | Puncture | Tear | Tear |
| (TF-BOPE20// | MD | MD | MD | TD | TD | TD | A | Force | MD | TD |
| PE80) | (MPa) | (%) | (MPa) | (MPa) | (%) | (MPa) | (g) | (N) | (mN) | (mN) |
| Comp. Ex. B | 24.94 | 248.69 | 368.2 | 60.6 | 46.84 | 578.32 | 777 | 122.3 | 76.7 | 50.5 |
| Inv. Ex. 4 | 27.87 | 227.18 | 394.95 | 52.43 | 45.49 | 606.29 | 723 | 123.4 | 94 | 56.9 |
| Inv. Ex. 5 | 25.97 | 335.88 | 451.81 | 45.41 | 44.32 | 634.76 | 657 | 93.44 | 87.76 | 59.02 |
| Inv. Ex. 6 | 28.46 | 244.25 | 436.68 | 58.21 | 43.32 | 672.68 | 815 | 103.96 | 68.91 | 56.55 |

The mechanical properties of the blown PE films prepared in the Examples are described in Table III. With a high toughness resin such as INNATE™, the PE films with 30 wt % or 40 wt % of PCR loading (Inv. Ex. 1-3) exhibit similar or even better performance properties than the PE film of Comp. Ex. A.

Table IV shows the mechanical properties of lamination films of the Examples. When compared to the comparative example (Comp. Ex. B), the lamination films of the present invention (Inv. Ex. 4-5) with PCR exhibit similar performances regarding mechanical properties compared to the comparative example (Comp. Ex. B). The PCR also improves the stiffness of the lamination films, which is beneficial for processing the lamination film on a Vertical Form Fill Seal (VFFS) packaging line.

The results of the Examples described in Tables III and IV show that when PCR is incorporated with high toughness PE resins, the PE resins containing PCR used to make the lamination films have comparable performance to all-PE lamination films with virgin PE resins; and the PCR-containing PE lamination films exhibit properties that are suitable for non-food packaging applications. For example, the PCR-containing PE lamination films are run on a VFFS line without processing issues, and packaging made from the lamination films of the present invention passes the 1.5 m/6 times drop test, a test commonly used in the art of evaluating packaging and lamination films.

What is claimed is:

1. A lamination film structure comprising:
(a) at least one first layer of an oriented polyethylene film; and
(b) at least one second layer of a blown or cast polyethylene film, wherein the at least one first layer of an oriented polyethylene film is laminated with the at least one second layer of a blown or cast polyethylene film; and
wherein the blown or cast polyethylene film of component (b) comprises a formulated resin including a combination or mixture of:
(bi) a predetermined amount of a post-consumer recycled resin sourced from a recycled high density polyethylene resin; and
(bii) a predetermined amount of a polyethylene resin; wherein the polyethylene resin, component (bii) includes:
(biiα) a linear low density polyethylene resin;
(biiβ) a low density polyethylene resin; or
(biiγ) a combination of (biiα) a linear low density polyethylene resin and (biiβ) a low density polyethylene resin;
wherein the performance and mechanical properties of the lamination film structure containing the predetermined amount of post-consumer recycled material are maintained at a level comparable to a lamination film structure that does not contain any amount of post-consumer recycled material.

2. The film structure of claim 1, wherein the oriented polyethylene film of component (a) is a tenter frame biaxially oriented polyethylene.

3. The film structure of claim 1, wherein the melt index of the post-consumer recycled material is less than 20 g/10 min; and wherein the density of the post-consumer recycled material is from 0.94 g/cc to 0.97 g/cc.

4. The film structure of claim 1, wherein the concentration of the post-consumer recycled material in the formulated resin for forming the blown or cast polyethylene film, component (b), is from 40 weight percent to 100 weight percent.

5. The film structure of claim 1, wherein the formulated resin to form the blown or cast polyethylene film, component (b), includes a linear low density polyethylene sufficient to boost the toughness and the sealing performance of the blown or cast polyethylene film.

6. The film structure of claim 5, wherein the concentration of the linear low density polyethylene in the formulated resin for forming the blown or cast polyethylene film, component (b), is from 0 weight percent to 60 weight percent.

7. The film structure of claim 5, wherein the linear low density polyethylene in the formulated resin to form the blown or cast polyethylene film is prepared using a Ziegler-Natta catalyst or a metallocene catalyst, and the co-monomer is octene or hexane, or a mixture thereof.

8. The film structure of claim 5, wherein the melt index of the linear low density polyethylene is less than 20 g/10 min; and wherein the density of the linear low density polyethylene is from 0.89 g/cc to 0.95 g/cc.

9. A process for making the polyethylene lamination film structure of claim 1 comprising laminating together: (a) at least one first layer of an oriented polyethylene film; and (b) at least one second layer of a blown or cast polyethylene film;
wherein the blown or cast polyethylene film of component (b) comprises a formulated resin including a combination or mixture of:
(bi) a predetermined amount of a post-consumer recycled resin sourced from a recycled high density polyethylene resin; and
(bii) a predetermined amount of a polyethylene resin; wherein the polyethylene resin, component (bii) includes:
(biiα) a linear low density polyethylene resin;
(biiβ) a low density polyethylene resin; or
(biiγ) a combination of (biiα) a linear low density polyethylene resin and (biiβ) a low density polyethylene resin;
wherein the performance and mechanical properties of the lamination film containing the predetermined amount of post-consumer recycled material are maintained at a level comparable to a lamination film that does not contain any amount of post-consumer recycled material.

10. A packaging, film or article made from a recyclate of the polyethylene lamination film structure of claim 1.
